(19) United States
(12) Patent Application Publication
(10) Pub. No.: US 2013/0125537 A1
(43) Pub. Date: May 23, 2013

(54) SWIRL FLOW CONTROL SYSTEM FOR CONSTRUCTION EQUIPMENT AND METHOD OF CONTROLLING THE SAME

(71) Applicant: Dong-Soo Kim, Jinhae-si (KR)

(72) Inventor: Dong-Soo Kim, Jinhae-si (KR)

(73) Assignee: VOLVO CONSTRUCTION EQUIPMENT AB, Eskilstuna (SE)

(21) Appl. No.: 13/812,780

(22) PCT Filed: Jul. 30, 2010
(86) PCT No.: PCT/KR2010/005013

§ 371 Date: Jan. 28, 2013

(51) Int. Cl. F15B 15/20

(52) U.S. Cl. CPC F15B 15/20
USPC 60/327; 60/445

(57) ABSTRACT

A swing flow control system for a construction machine is provided, which includes an engine; a plurality of actuators for working devices; a variable displacement hydraulic pump providing hydraulic pressure to the actuators for the working devices and the swing motor; an operation portion including an operation lever or a joystick and instructing movement of the plurality of actuators; a control valve supplying a flow rate of the hydraulic pump to the actuators and the swing motor by the operation portion; a working device position detection means, installed on one side of the actuator; an operation amount sensing means, connected to one side of the operation portion; and a flow controller including a flow setting unit and an output means for providing a control signal to a swash plate control device to receive a signal sensed by the operation amount sensing means.

### TECHNICAL FIELD

The present invention relates to a swing flow control system for a construction machine and a control method thereof. More particularly, the present invention relates to a swing flow control apparatus for a construction machine, which can heighten energy efficiency by reducing hydraulic energy that is consumed in a relief valve through limiting a flow rate of hydraulic fluid that is discharged from a hydraulic pump while an upper swing structure is accelerated.

### BACKGROUND ART

In a hydraulic apparatus and a hydraulic circuit for a construction machine including an excavator, various researches and development for efficiently performing high-load work conditions that are required in a working device including a boom, an arm, or a bucket, a traveling device, and a swing device have been continuously made.

A hydraulic pump discharges hydraulic fluid depending on the operation angle of an operation lever or pilot pressure regardless of loads in respective works, and discharges the hydraulic fluid with the maximum flow rate only in the case where the operation lever is maximally operated or the pilot pressure exceeds a preset pressure.

According to the hydraulic apparatus for a construction machine in the related art, if an operation amount signal is input from an operation amount sensing means, a flow calculation means determines preferred pump discharge flow rate for the operation amount, and controls a swash plate control device of the hydraulic pump through an output means with current that corresponds to the flow rate value.

Normally, if an operator intends to perform an abrupt swing operation, the operation lever is moved abruptly, and the input signal sensed by the operation amount sensing means is abruptly increased. At this time, a flow path is formed from the hydraulic pump to the swing motor, and thus the flow rate of the hydraulic pump is abruptly increased to cause the occurrence of sudden acceleration.

At this time, in order to protect the swing motor and the swing device, a relief valve is used to limit the torque or excessive pressure input to the swing motor below a predetermined value.

That is, the flow rate supplied from the hydraulic pump is increased, and if the pressure in the relief valve exceeds a predetermined pressure, excessive flow rate, except for the flow rate that is used to rotate the swing motor, returns to the hydraulic tank. Accordingly, energy that is in proportion to the returning flow rate and the relief pressure is lost to deteriorate the fuel efficiency of the equipment.

Consequently, in the hydraulic apparatus and hydraulic circuit in the related art, although high flow rate is not required until the rotation of the upper swing structure is accelerated during a swing operation, the hydraulic pump always discharges maximum flow rate while the upper swing structure is rotated, and thus energy loss that is in proportion to the returning flow rate and the relief pressure occurs to cause the fuel consumption to be greatly increased.

### DISCLOSURE

### Technical Problem

Therefore, the present invention has been made to solve the above-mentioned problems occurring in the related art, and one embodiment of the present invention is related to a swing flow control system for a construction machine and a control method thereof, which can heighten energy efficiency by reducing hydraulic energy that is consumed in a relief valve through limiting a flow rate of hydraulic fluid that is discharged from a hydraulic pump while an upper swing structure is accelerated.

### Technical Solution

In accordance with one aspect of the present invention, there is provided a swing flow control system for a construction machine, including: an engine; a plurality of actuators for working devices including a boom, an arm, and a bucket and a swing motor; a variable displacement hydraulic pump connected to the engine to provide hydraulic pressure to the actuators for the working devices and the swing motor; an operation unit including an operation lever or a joystick and instructing movement of the plurality of actuators; a control valve supplying hydraulic fluid of the hydraulic pump to the actuators and the swing motor by the operation unit; a working device position detection means, installed on one side of the actuator, for sensing a relative position of the actuator; an operation amount sensing means, connected to one side of the operation unit, for sensing an operation amount of the operation lever or the joystick; and a flow controller installed to be connected to the operation amount sensing means and a swash plate control device to receive a signal sensed by the operation amount sensing means and to control a discharge flow rate of the hydraulic pump, wherein the flow controller includes a flow setting unit receiving the signal from the operation amount sensing means and setting the discharge flow rate of the hydraulic pump, a flow limit unit receiving a signal from the working device position detection means, reducing an increment rate of the flow rate of the hydraulic pump if the working device is in a position where a rotational inertia is above a predetermined value, and increasing the increment rate if the working device is in a position where the rotational inertia is below the predetermined value, and an output means providing a control signal to the swash plate control device in order to limit the increment rate of the flow rate that is determined by the flow limit unit.

In accordance with another aspect of the present invention, there is provided a method for controlling a swing flow control system for a construction machine, which includes an engine 1; a plurality of actuators for working devices including a boom, an arm, and a bucket and a swing motor; a variable displacement hydraulic pump connected to the engine to provide hydraulic pressure to the actuators for the working devices and the swing motor; an operation unit including an operation lever or a joystick and instructing movement of the plurality of actuators; a control valve supplying a flow rate of the hydraulic pump to the actuators and the swing motor by the operation unit; a working device position detection means, installed on one side of the actuator, for sensing a relative position of the actuator; an operation amount sensing means, connected to one side of the operation unit, for sensing an operation amount of the operation lever or the joystick; and a flow controller connected to the operation amount sensing means and a swash plate control device to receive a signal sensed by the operation amount sensing means and to control a discharge flow rate of the hydraulic pump, the method including receiving the signal from the operation amount sensing means and calculating a swing requirement flow rate Qr (S1); calculating a change rate dQr of the swing requirement flow rate Qr (S2); and compensating for a required swing motor displacement Dr by comparing the change rate dQr of the swing requirement flow rate Qr with a slope S(a) of a preset reference state.

In accordance with the aspect of the present invention, the signal of the operation amount sensing means and a signal of the swash plate control device include an electric solenoid control signal or pilot signal pressure.

### Advantageous Effect

According to the swing flow control system for a construction machine according the aspects of the present invention, in order to minimize the loss flow rate that returns to the relief valve during an abrupt swing operation, the flow rate is limited with the optimum flow limit slope b that is changed depending on the rotating state of the upper swing structure through comparison of the flow rate with the reference state, the system hydraulic pressure due to the rotational inertia of the upper swing structure that is changed depending on the state of the working device is compared with the predetermined reference pressure, and the swing requirement slope c in proportion to a difference between the system hydraulic pressure and the reference pressure is compensated for to minimize the flow loss.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a diagram illustrating the configuration of a hydraulic pump control system according to an embodiment of the present invention;

FIG. 2 is a diagram illustrating the configuration of a hydraulic pump control block during a swing operation according to an embodiment of the present invention;

FIGS. 3A and 3B are graphs illustrating the relief pressure and flow control characteristics during a swing operation according to an embodiment of the present invention; and

FIG. 4 is a flowchart illustrating a method for controlling a swing requirement flow rate during a swing operation according to an embodiment of the present invention.

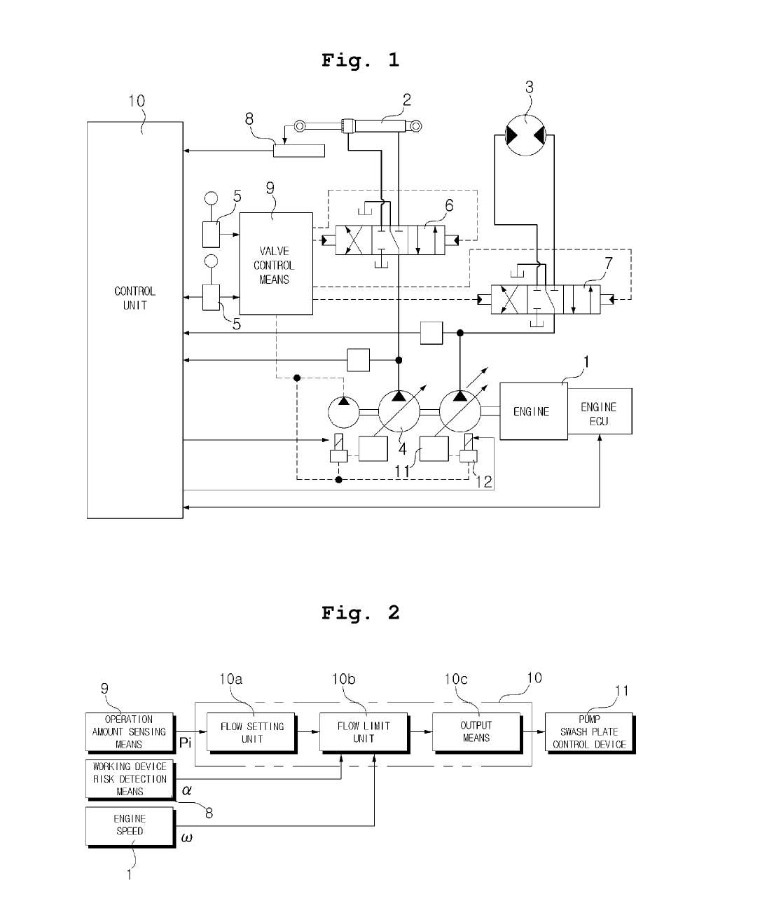

### BEST MODE

Terminology or words used in the description and claims should not be understood to be limited to the typical or dictionary meanings, but should be analyzed as meanings and concept that coincide with the technical idea of the present invention based on the principle that the inventors can appropriately define the concept of the terminology to explain their invention in the best method.

Hereinafter, preferred embodiments of the present invention will be described in detail with reference to the accompanying drawings.

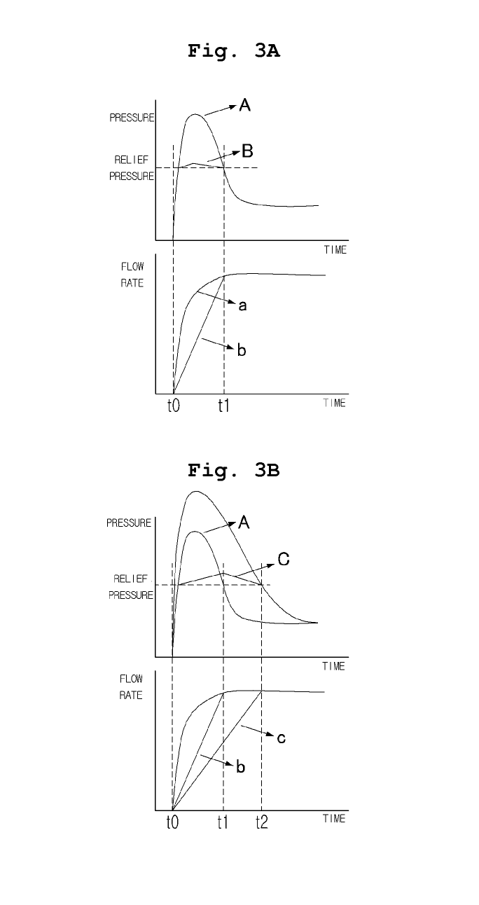

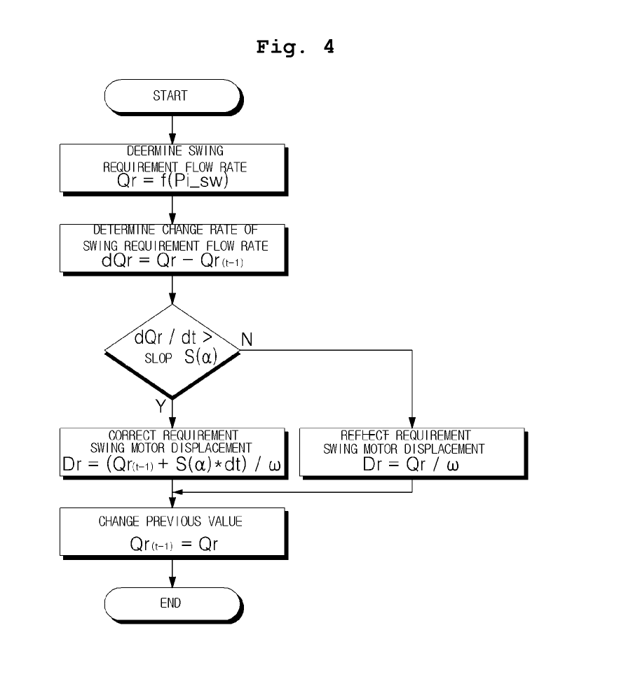

Referring to FIGS. 2 and 3, according to an embodiment of the present invention, a swing flow control system for a construction machine includes an engine 1; a plurality of actuators 2 for working devices including a boom, an arm, and a bucket and a swing motor 3; a variable displacement hydraulic pump 4 connected to the engine 1 to provide hydraulic pressure to the actuators 2 for the working devices and the swing motor 3; an operation unit 5 including an operation lever or a joystick and instructing movement of the plurality of actuators 2; a control valve 6 or 7 supplying hydraulic fluid of the hydraulic pump 4 to the actuators 2 and the swing motor 3 by the operation unit 5; a working device position detection means 8, installed on one side of the actuator 2, for sensing a relative position of the actuator 2; an operation amount sensing means 9, connected to one side of the operation unit 5, for sensing an operation amount of the operation lever or the joystick; and a flow controller 10 installed to be connected to the operation amount sensing means 9 and a swash plate control device 11 to receive a signal sensed by the operation amount sensing means 9 and to control a discharge flow rate of the hydraulic pump 4, wherein the flow controller 5 includes a flow setting unit 10a receiving the signal from the operation amount sensing means 9 and setting the discharge flow rate of the hydraulic pump 4, a flow limit unit 10b receiving a signal from the working device position detection means 8, reducing an increment rate of the flow rate of the hydraulic pump 4 if the working device is in a position where a rotational inertia is above a predetermined value, and increasing the increment rate if the working device is in a position where the rotational inertia is below the predetermined value, and an output means 10c providing a control signal to the swash plate control device in order to limit the increment rate of the flow rate that is determined by the flow limit unit 10b.

Preferably, the flow limit unit 10b may be configured to include an operator that calculates the increment rate according to the position detection signal of the working device position detection means 8 with a predetermined algorithm or table, and the flow setting unit 10a of the flow controller 5 may receive the signals from the operation amount sensing means 9 and the speed sensor (not illustrated) of the engine 1 and set the discharge flow rate of the hydraulic pump 4.

In the swing flow control system for a construction machine according to an embodiment of the present invention, the flow controller 5 may be configured to include a flow setting unit 10a receiving the signals from the operation amount sensing means 9 and setting the discharge flow rate of the hydraulic pump 4, a flow limit unit 10b receiving the signals from the working device position detection means 8 and the speed sensor (not illustrated) of the engine 1 and calculating an increment rate of the flow rate to compensate for the swing requirement flow rate, and an output means 10c providing a control signal to the swash plate control device 11 in order to limit the increment rate of the flow rate to the swing requirement slope c calculated by the flow limit unit 10b.

The signal of the operation amount sensing means 9 and a signal of the swash plate control device 11 include an electric solenoid control signal or pilot signal pressure.

According to the swing flow control system for a construction machine as constructed above according to an embodiment of the present invention, if hydraulic fluid of a sufficient flow rate is supplied from the hydraulic pump 4 so that constant pressure is maintained in the swing motor 3, a torque Tm input from the swing motor 3 is constantly set from the following equation.

Tm=Km*P*Dm=J*dω/dt+B*ω

(where, Km denotes a torque constant, Dm denotes a swing motor displacement, J denotes a rotational inertia of an upper swing structure, and B denotes a resistance coefficient for a speed.)

Here, if it is assumed that the resistance force for the rotating speed is low, the torque that is applied to the swing motor is constant, and the increment rate of the rotating speed of the upper swing structure that includes the working device actuator 2 becomes constant.

On the contrary, if the increment rate of the flow rate input to the swing motor 3 is maintained constant, the hydraulic pressure of the hydraulic system formed between the swing motor 3 and the hydraulic pump 4 is limited to a constant value, and the pressure is in proportion to the slope of the increment rate of the flow rate.

That is, as illustrated in FIG. 3A, if the increment rate of the flow rate is limited to the swing requirement slop b when a preferred required swing motor displacement Dr by the operation amount signal sensed from the operation amount sensing means 9 of the operation unit 5 is calculated, the pressure of the hydraulic pump 4 is limited to the pressure B near the relief pressure, and the loss caused by the hydraulic fluid that returns to the tank by the relief can be minimized to obtain the maximum acceleration.

On the other hand, as illustrated in FIG. 3B, the rotational inertia of the upper swing structure is changed when a boom or arm working device is maximally spread or when the heavy excavating process is performed using a bucket working device. If it is assumed that the optimum flow limit slope for the rotational inertia of the upper swing structure that is changed at that time is c, and the flow rate is limited to the swing requirement slope b, the flow rate that exceeds the flow limit slope c returns to the hydraulic tank through the relief valve to cause a loss.

In this case, in the related art, an override phenomenon of the relief valve, where the pressure is linearly increased depending on the relieved flow rate, and the pressure of the hydraulic pump 4 is increased depending on the flow rate being lost.

According to the swing flow control system for a construction machine according an embodiment of the present invention, in order to minimize the loss flow rate that returns to the relief valve during an abrupt swing operation, the flow rate is limited with the optimum flow limit slope b that is required depending on the rotating state of the upper swing structure with respect to the reference state (for example, standstill state of the upper swing structure), the system hydraulic pressure due to the rotational inertia of the upper swing structure that is changed depending on the state of the working device is compared with the predetermined reference pressure, and the swing requirement slope c in proportion to a difference between the system hydraulic pressure and the reference pressure is compensated for to minimize the flow loss.

According to another embodiment of the present invention, a method for controlling a swing flow control system for a construction machine, including an engine 1; a plurality of actuators 2 for working devices including a boom, an arm, and a bucket and a swing motor 3; a variable displacement hydraulic pump 4 connected to the engine 1 to provide hydraulic pressure to the actuators 2 for the working devices and the swing motor 3; an operation unit 5 including an operation lever or a joystick and instructing movement of the plurality of actuators 2; a control valve 6 or 7 supplying hydraulic fluid of the hydraulic pump 4 to the actuators 2 and the swing motor 3 by the operation unit 5; a working device position detection means 8, installed on one side of the actuator 2, for sensing a relative position of the actuator 2; an operation amount sensing means 9, connected to one side of the operation unit 5, for sensing an operation amount of the operation lever or the joystick; and a flow controller 10 installed to be connected to the operation amount sensing means 9 and a swash plate control device 11 to receive a signal sensed by the operation amount sensing means 9 and to control a discharge flow rate of the hydraulic pump 4, the method includes receiving the signal sensed from the operation amount sensing means 9 and calculating a swing requirement flow rate Qr (S1); calculating a change rate dQr of the swing requirement flow rate Qr (S2); and compensating for a required swing motor displacement Dr by comparing the change rate dQr of the swing requirement flow rate Qr with a slope S(a) of a preset reference state.

Referring to FIG. 4, the change rate dQr of the swing requirement flow rate Qr is determined by a relation of dQr=Qr−Qr(t−1). Thereafter, the required swing motor displacement Dr is compensated for by comparing the change rate dQr of the swing requirement flow rate Qr, which is changed depending on the relative position that is sensed by the working device position detection means 8, with the slope S(a) of the preset reference state (step S3).

In the above-described step S3, if the change rate dQr of the swing requirement flow rate Qr is lower than the slope S(a) of the preset reference state, the required swing motor displacement Dr is determined by a relation of Dr=(Qr(t−1)+S(α)*dt)/ω as described in FIG. 4. By contrast, if the change rate dQr of the swing requirement flow rate Qr is higher than the slope S(α) of the preset reference state, the required swing motor displacement Dr is determined depending on the speed (w) of the engine 1.

Here, the swing requirement flow rate Qr may be controlled by the flow setting unit 10a which receives signals related to the operation amount of a worker sensed by the operation amount sensing means 9 and the speed of the engine 1 and sets the discharge flow rate of the hydraulic pump 4, and the flow limit unit 10b which receives a signal from the working device position detection means 8, reduces the increment rate of the flow rate of the hydraulic pump 4 if the working device is in a position where the rotational inertia is above a predetermined value, and increases the increment rate if the working device is in a position where the rotational inertia is below the predetermined value.

On the other hand, the above-described compensation may also be performed by experimentally obtaining in advance the correction value of the flow limit slope that corresponds to the relative position through detection of the relative position with the upper swing structure including the boom or arm or by calculating the correction value of the optimum slope for the corresponding inertia value through estimation of the rotational inertia that corresponds to the relative position.

Further, in the same manner as described above, the flow controller 5 is configured to include the flow setting unit 10a receiving the signals from the operation amount sensing means 9 and the speed sensor (not illustrated) of the engine 1 and setting the discharge flow rate of the hydraulic pump 4, the flow limit unit 10b receiving the signal from the working device position detection means 8, reducing the increment rate of the flow rate of the hydraulic pump 4 if the working device is in a position where the rotational inertia is above a predetermined value, and increasing the increment rate if the working device is in a position where the rotational inertia is below the predetermined value, and the output means 10c providing a control signal to the swash plate control device in order to limit the increment rate of the flow rate that is determined by the flow limit unit 10b.

### INDUSTRIAL APPLICABILITY

As apparent from the above description, according to the swing flow control system for a construction machine according the aspects of the present invention, in order to minimize the loss flow rate that returns to the relief valve during an abrupt swing operation, the flow rate is limited with the optimum flow limit slope c that is changed depending on the rotating state of the upper swing structure through comparison of the flow rate with the reference state, the system hydraulic pressure due to the rotational inertia of the upper swing structure that is changed depending on the state of the working device is compared with the predetermined reference pressure, and the swing requirement slope in proportion to a difference between the system hydraulic pressure and the reference pressure is compensated for to minimize the flow loss.

1. A swing flow control system for a construction machine comprising:
an engine;
a plurality of actuators for working devices including a boom, an arm, and a bucket and a swing motor;
a variable displacement hydraulic pump connected to the engine to provide hydraulic pressure to the actuators for the working devices and the swing motor;
an operation unit including an operation lever or a joystick and instructing movement of the plurality of actuators;
a control valve supplying hydraulic fluid of the hydraulic pump to the actuators and the swing motor by the operation unit;
a working device position detection means, installed on one side of the actuator, for sensing a relative position of the actuator; an operation amount sensing means, connected to one side of the operation unit, for sensing an operation amount of the operation lever or the joystick; and
a flow controller installed to be connected to the operation amount sensing means and a swash plate control device to receive a signal sensed by the operation amount sensing means and to control a discharge flow rate of the hydraulic pump,
wherein the flow controller includes a flow setting unit receiving the signal from the operation amount sensing means and setting the discharge flow rate of the hydraulic pump, a flow limit unit receiving a signal from the working device position detection means, reducing an increment rate of the flow rate of the hydraulic pump if the working device is in a position where a rotational inertia is above a predetermined value, and increasing the increment rate if the working device is in a position where the rotational inertia is below the predetermined value, and an output means providing a control signal to the swash plate control device in order to limit the increment rate of the flow rate that is determined by the flow limit unit.

2. A method for controlling a swing flow control system for a construction machine, including:
an engine;
a plurality of actuators for working devices including a boom, an arm, and a bucket and a swing motor;
a variable displacement hydraulic pump connected to the engine to provide hydraulic pressure to the actuators for the working devices and the swing motor;
an operation unit including an operation lever or a joystick and instructing movement of the plurality of actuators;
a control valve supplying a flow rate of the hydraulic pump to the actuators and the swing motor by the operation unit;
a working device position detection means, installed on one side of the actuator, for sensing a relative position of the actuator;
an operation amount sensing means, connected to one side of the operation unit, for sensing an operation amount of the operation lever or the joystick; and
a flow controller connected to the operation amount sensing means and a swash plate control device to receive a signal sensed by the operation amount sensing means and to control a discharge flow rate of the hydraulic pump,
the method comprising:
receiving the signal from the operation amount sensing means and calculating a swing requirement flow rate Qr (S1);
calculating a change rate dQr of the swing requirement flow rate Qr (S2); and
compensating for a required swing motor displacement Dr by comparing the change rate dQr of the swing requirement flow rate Qr with a slope S(a) of a preset reference state.

3. The method for controlling a swing flow control system for a construction machine according to claim 2, wherein the signal of the operation amount sensing means and a signal of the swash plate control device include an electric solenoid control signal or pilot signal pressure.
